(19) United States
(12) Patent Application Publication
(10) Pub. No.: US 2026/0213288 A1
(43) Pub. Date: Jul. 23, 2026

(54) SELF CHECKING SYSTEM FOR INSPECTION DEVICE

(71) Applicant: SK On Co., Ltd., Seoul (KR)

(72) Inventors: Do Young KIM, Daejeon (KR); Min Gyu LEE, Daejeon (KR)

(21) Appl. No.: 19/454,383

(22) Filed: Jan. 21, 2026

(30) Foreign Application Priority Data
Jan. 21, 2025 (KR) 10-2025-0008712

(51) Int. Cl. H01M 10/42; G06T 7/00; G06T 7/62; G06T 7/73

(52) U.S. Cl. CPC H01M 10/4285; G06T 7/0008; G06T 7/001; G06T 7/62; G06T 7/74; G06T 2207/30164

(57) ABSTRACT

The present disclosure relates to a self-checking system for an inspection device. The self-checking system for an inspection device may comprise: a stage, an object to be inspected placed on the stage, a plurality of imaging devices arranged around the object, a determination unit determining whether there is an offset between the object and placements of the plurality of imaging devices based on a plurality of images obtained from the plurality of imaging devices, and an alarm unit alerting the presence or absence of the offset determined by the determination unit.

The present application claims priority under 35 U.S.C. § 119a to Korean patent applications number 10-2025-0008712 filed on January 21, 2025 in the Ministry of Intellectual Property in Korea, the entire disclosures of which are incorporated by reference herein.

### BACKGROUND OF THE DISCLOSURE

### 1. Field

This disclosure relates to a diagnostic system for secondary batteries, specifically a self-checking system for an inspection device that diagnoses secondary batteries.

### 2. Description of the Related Art

The demand for secondary batteries as energy sources powering various electronic devices such as smartphones, laptops, vehicles, and drones is rapidly increasing. Particularly, research on battery modules for secondary batteries used to power vehicles and similar applications is actively underway.

Generally, secondary batteries are manufactured through various automated and continuous processes. Therefore, maintaining battery quality during the conveying stages of the production line is crucial.

For example, imaging devices used to inspect the quality of secondary batteries examine their appearance to assess quality. However, there is no existing system capable of managing these imaging devices or enabling self-checking within the imaging devices themselves.

Therefore, during visual inspections for secondary battery quality, it is often unclear whether a signal indicating a defect is caused by the battery's poor quality or by a malfunction in the imaging device itself.

Particularly, defective quality in secondary batteries not only leads to performance degradation or failure but also poses a risk of short circuits occurring within the battery module, potentially causing fires or explosions.

Therefore, a system enabling the imaging device, which is the inspection device, to perform self-checking is needed to accurately inspect secondary battery quality defects.

This disclosure provides a self-checking system for the inspection devices to reduce the cost of secondary battery quality inspection and enable accurate collection of data related to secondary battery quality.

According to one aspect of the present disclosure, an object is to provide self-checking criteria of the inspection device used to inspect the quality of secondary batteries.

### SUMMARY OF THE DISCLOSURE

A self-checking system for an inspection device according to an embodiment of this disclosure may comprise: a stage, an object to be inspected placed on the stage, a plurality of imaging devices arranged around the object, a determination unit determining whether there is an offset between the object and placements of the plurality of imaging devices based on a plurality of images obtained from the plurality of imaging devices, and an alarm unit alerting the presence or absence of the offset determined by the determination unit.

In an embodiment, the plurality of imaging devices may include: a top imaging device positioned on a top-surface of the object to obtain a top-surface image, and a side imaging device positioned on a side of surface of the object to obtain a side-surface image.

In an embodiment, the stage may include a plurality of side walls standing upright from a bottom surface of the stage.

In an embodiment, the stage may include a top pixel area formed in a corner region of the bottom surface of the stage.

In an embodiment, the stage may include a side pixel area formed in a corner region of the side wall.

In an embodiment, the determination unit may determine that the placement of the top imaging device or the side imaging device is misaligned when the mapping value of the top pixel area or the side pixel area exceeds a reference mapping value.

In an embodiment, the determination unit may calculate a first distance from a reference point of the object within the top-surface image to the top pixel area, and determines that the placement position of the object is misaligned when the first distance exceeds a first distance reference value range.

In an embodiment, the alarm unit may generate a first alarm sound when the determination unit determines that the placement position of the object is misaligned.

In an embodiment, the determination unit may calculate a second distance from a reference point of the stage within the top-surface image to the top pixel area, and determines that the placement of the top imaging device is misaligned when the second distance exceeds a second distance reference value range.

In an embodiment, the alarm unit may generate a second alarm sound when the determination unit determines that the placement of the top imaging device is misaligned.

In an embodiment, the determination unit may calculate a third distance from a reference point of the object within the side image to the side pixel area, and determines that the placement of the object is misaligned when the third distance exceeds a third distance reference value range.

In an embodiment, the alarm unit may generate a third alarm sound when the determination unit determines that the placement position of the object is misaligned.

In an embodiment, the determination unit may calculate a fourth distance from a reference point on the stage within the side image to the top pixel area, and determines that the placement of the side imaging device is misaligned when the fourth distance exceeds a fourth distance reference value range.

In an embodiment, the alarm unit may generate a fourth alarm sound when the determination unit determines that the placement of the side imaging device is misaligned.

An embodiment of the present disclosure may provide a self-checking system for a new type of inspection device.

An embodiment of the present disclosure may provide a self-checking system for the inspection device during an automated manufacturing process of a secondary battery.

An embodiment of the present disclosure may maintain an imaging device during an automated manufacturing process for secondary batteries.

An embodiment of the present disclosure may self-check misalignments of the secondary battery and misalignments of the imaging devices during the automated manufacturing process of the secondary battery.

An embodiment of the present disclosure may provide a self-checking system for the inspection device that may prevent secondary battery quality defects in advance, thereby enabling improvement in secondary battery quality.

Meanwhile, the self-checking system for the inspection device according to an embodiment of the present disclosure may be widely applied in green technology fields such as electric vehicles, battery charging stations, energy storage systems, and other green technologies utilizing battery cells, such as photovoltaics and wind power.

Furthermore, the self-checking system for the inspection device according to an embodiment of the present disclosure may be used in eco-friendly mobility, including electric vehicles and hybrid vehicles, to prevent climate change by suppressing air pollution and greenhouse gas emissions.

### BRIEF DESCRIPTION OF THE DRAWINGS

FIG. 1 is a conceptual diagram schematically illustrating a self-checking system for an inspection device according to an embodiment of the present disclosure.

FIG. 2 schematically shows a misaligned placement position of an object in the self-checking system for the inspection device according to an embodiment of the present disclosure.

FIG. 3 schematically shows a misalignment in the placement of the top imaging device within the self-checking system for the inspection device according to an embodiment of the present disclosure.

FIG. 4 is a flowchart schematically illustrating a step of determining whether the placement of the object and the placement of the top imaging device are misaligned through a self-checking system for the inspection device according to an embodiment of the present disclosure.

FIG. 5 schematically shows a misalignment of the placement of the object in the self-checking system for the inspection device according to another embodiment of the present disclosure.

FIG. 6 schematically shows a misalignment of the side imaging device in the self-checking system for the inspection device according to another embodiment of the present disclosure.

FIG. 7 is a flowchart schematically illustrating a step of determining whether the placement of the object and the placement of the side imaging device are misaligned through a self-checking system for the inspection device according to another embodiment of the present disclosure.

### DETAILED DESCRIPTION

Hereinafter, with reference to the accompanying drawings, the self-checking system for the inspection device according to various embodiments of the present disclosure will be described through embodiments of the present disclosure.

Unless otherwise defined, all technical and scientific terms used herein have the meanings commonly understood by those skilled in the art. The terms used herein are intended to describe specific embodiments and are not intended to limit the disclosure. The terms "include," "comprise," and any variations thereof, as used herein, are intended to include non-exclusive inclusion.

Furthermore, the terms "first," "second," etc., in this disclosure are used to distinguish different objects and do not describe any specific order or sequence.

Furthermore, in embodiments, components having the same configuration are represented using the same reference numerals in one embodiment for illustrative purposes, while other embodiments describe only the different components.

The structural or functional descriptions of the embodiments disclosed in this specification or application are provided merely as examples to illustrate embodiments according to the technical concept of the present disclosure. Embodiments according to the technical concept of the present disclosure may be implemented in various forms beyond those disclosed in this specification or application. and the technical concept of the present disclosure shall not be construed as being limited to the embodiments described herein or in the application.

Meanwhile, in this disclosure, a secondary battery may include a battery cell, a cell, a battery, a secondary battery, or a battery pack.

The following drawings provide a more detailed description of the self-checking system 1 for an imaging device according to various embodiments of the present disclosure.

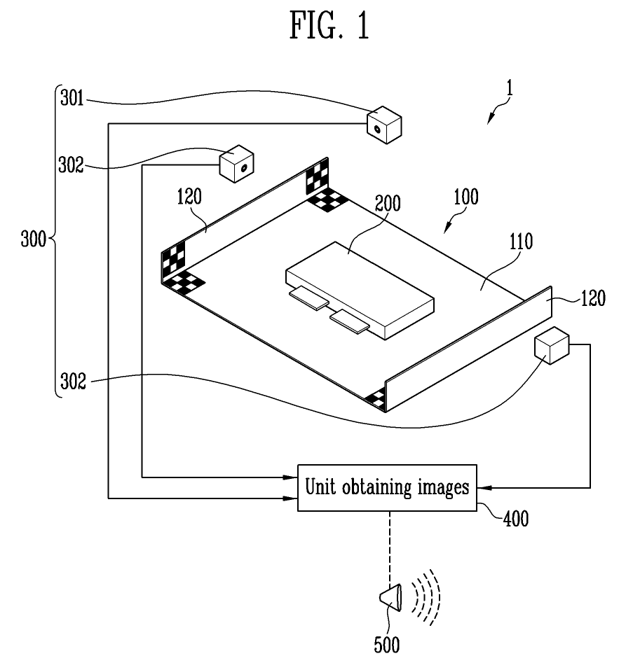

FIG. 1 is a conceptual diagram schematically illustrating a self-checking system 1 for an inspection device according to an embodiment of the present disclosure.

As shown in FIG. 1, the self-checking system 1 for an inspection device according to an embodiment of the present disclosure may include a stage 100, an object 200 to be inspected placed on the stage 100, a plurality of imaging devices 300 arranged around the object 200, a determination unit 400 determining whether there is an offset between the object 200 and placements of the plurality of imaging devices 300 based on a plurality of images obtained from the plurality of imaging devices 300, and an alarm unit 500 alerting the presence or absence of the offset determined by the determination unit 400.

For example, the object 200 to be inspected may include a prismatic battery, and the self-checking system 1 for the inspection device according to an embodiment of the present disclosure may be applied before conducting an appearance inspection after taping the prismatic battery. As mentioned above, in the case of prismatic batteries, they are heavy and difficult to handle, so it is necessary to apply the self-checking system 1 for the inspection device according to an embodiment of the present disclosure in advance.

For example, the stage 100 may include a plate capable of mounting a square battery, which is an object 200. This stage 100 can be transported along a conveyor (not shown) or similar transport logistics. Before performing an appearance inspection of the object 200 placed on the stage 100, the self-checking system 1 for the inspection device according to an embodiment of the present disclosure may be applied.

In an embodiment, the stage 100 may include a plurality of side walls 120 standing upright from a bottom surface 110 of the stage 100. Further, the stage 100 may include a top pixel area 113 formed in a corner region 112 of the bottom surface 110 of the stage 100. The stage 100 may include a side pixel area 123 formed in a corner region 122 of the side wall 120.

For example, in an embodiment of the present disclosure, the stage 100 may include a plurality of side walls 120 standing upright from the bottom surface 110 of the stage 100, and a side pixel area 123 capable of being mapped by the plurality of imaging devices 300 and the determination unit 400, described later, is formed in the side corner region 122 of the side wall 120. Furthermore, the top pixel area 113 capable of being mapped by the plurality of imaging devices 300 and the determination unit 400 is also formed in the corner region 112 of the bottom surface 110 of the stage 100. In the embodiments of the present disclosure, the top pixel area 113 and the side pixel area 123 are respectively placed on the corner region 112 of the stage 100 and the side corner region 122 of the side wall 120 of the stage 100. The location is not particularly limited as long as it is an area that can be mapped to the plurality of imaging devices 300 and the determination unit 400.

In one embodiment of the present disclosure, the mappable pixel areas 113, 123 may be formed in various patterns. For example, as shown in FIGS. 1 to 3, they may be provided as a chessboard pattern, wherein the chessboard pattern may be a pattern alternately providing square shapes with uncolored interiors and square shapes with colored interiors. Alternatively, although not shown, the mappable pixel area 113, 123 may be provided as a dot pattern, wherein the dot pattern may be provided as dot shapes within each square forming the aforementioned checkerboard pattern. For example, the dot shapes may be provided as colored dot shapes within the squares that are not colored in the chessboard pattern. For example, the dot shapes may be provided as uncolored dot shapes within the squares that are colored in the chessboard pattern.

In an embodiment of the present disclosure, the plurality of imaging devices 300 may be arranged in a plurality around the object 200 so that it can image the object 200 placed on the stage 100 from multiple directions.

In one embodiment of the present disclosure, the plurality of imaging devices 300 may include a top imaging device 301 positioned on a top-surface 210 of the object 200 to obtain a top-surface image, and a side imaging device 302 positioned on a side of surface 220 of the object 200 to obtain a side-surface image.

For example, the top imaging device 301 may be positioned higher than the stage 100 or the top-surface 210 of the object 200 to obtain an image of the stage 100 or the object 200. For example, the side imaging device 302 may be positioned at an oblique angle from a position higher than the top-surface 210 of the stage 100 or the object 200 to obtain an image of the stage 100 or the object 200 at an oblique angle.

The plurality of imaging devices 300 may be provided as a camera for obtaining an image of at least a portion of the stage 100 or the object 200. For example, the camera may include a vision camera, a 2D vision camera, or a charge-coupled device camera. For example, the plurality of imaging devices 300 may further include a light source member (not shown). For example, the light source member may be attached to the plurality of imaging devices 300 or installed separately externally to irradiate light around the stage 100 or the object 200. The light source of the light source member may provide laser light, visible light, infrared light, etc.

In one embodiment of the present disclosure, the determination unit 400 may determine whether there is an offset in the arrangement of the object 200 or the plurality of imaging devices 300 based on a plurality of images obtained from the plurality of imaging devices 300, and may alert an operator of the determined offset status via the alarm unit 500.

For example, the determination unit 400 may analyze the plurality of images obtained from the plurality of imaging devices 300 to determine whether an offset exists in the arrangement of the object 200 or the plurality of imaging devices 300. The specific method for determining the offset will be described later.

For example, the determination unit 400 refers to a unit that handles at least one function or operation, which may be implemented by hardware, software, or a combination of hardware and software. For example, in the case of hardware, it may be implemented as an application specific integrated circuit, digital signal processing, programmable logic device, field programmable gate array, processor, controller, microprocessor, other electronic unit, or a combination thereof, designed to perform the aforementioned functions. For instance, in a software implementation, it may be implemented as a module performing the aforementioned functions. The software may be stored in a memory unit and executed by a processor. The memory unit or processor may employ various means well known to those skilled in the art.

Furthermore, in one embodiment of the present disclosure, the determination unit 400 may include a program that performs an algorithm for mapping the pixel areas 113, 123, calculating the distance from the obtained images to the pixel areas 113, 123, and comparing the calculated distance with a reference value range, and a storage unit (not shown) that stores processed signals, etc.

For example, the storage unit may be a memory provided within the determination unit 400 or may be a separate memory. Therefore, it may include non-volatile memory such as a flash memory disk (Solid State Disk), hard disk drive, flash memory, Electrically Erasable Programmable Read-Only Memory, Static RAM, Ferro-electric RAM, Phase-change RAM, Magnetic RAM, and the like, and/or volatile memory such as Dynamic Random Access Memory, Synchronous Dynamic Random Access Memory, Double Data Rate SDRAM, and the like.

In an embodiment, the determination unit 400 may determine that the placement of the top imaging device 301 or the side imaging device 302 is misaligned when the mapping value of the top pixel area 113 or the side pixel area 123 exceeds a reference mapping value.

For example, prior to performing self-checking of the inspection device, the determination unit 400 may determine that the placement of the top imaging device 301 or the side imaging device 302 is misaligned if the mapping value of the top pixel area 113 or the side pixel area 123 exceeds a predetermined reference mapping value.

For example, the determination unit 400 may calculate the mapping value by comparing an image captured by the top imaging device 301 or side imaging device 302 of the pixel area 113, 123 at an oblique angle with a forward-looking image of the pixel area stored in the determination unit 400, and If the mapping value of the top pixel area 113 or the side pixel area 123 exceeds a predetermined reference mapping value, it can be determined that the arrangement of the top imaging device 301 or the side imaging device 302 is misaligned before operating the self-checking system 1 for the inspection device according to one embodiment of the present disclosure.

In an embodiment, the alarm unit may generate a first alarm sound when the determination unit determines that the placement position of the object is misaligned.

For example, when the alarm unit 500 obtains a predetermined determination result from the determination unit 400, it may alarm the operator about the presence of a determined offset or an alarm signal.

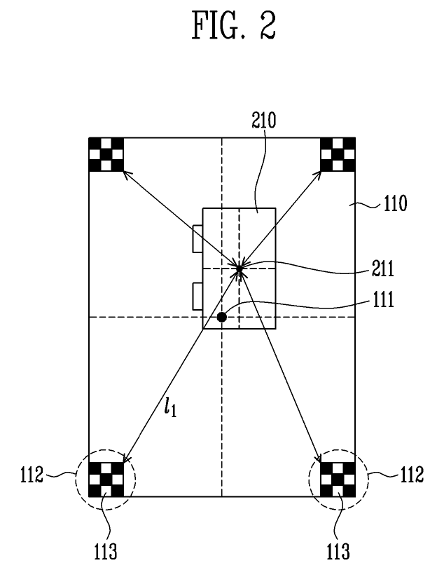

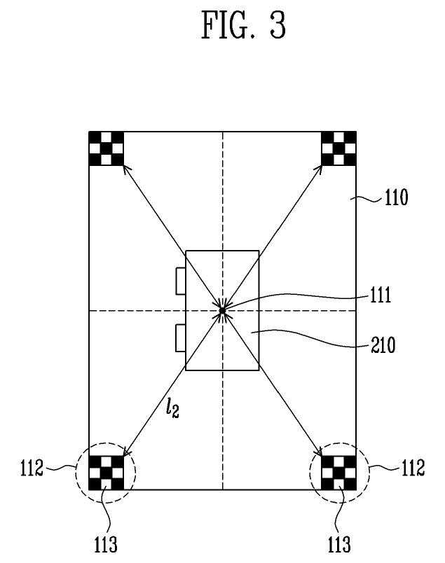

FIG. 2 schematically shows a misaligned placement position of an object in the self-checking system 1 for the inspection device according to an embodiment of the present disclosure. FIG. 3 schematically shows a misalignment in the placement of the top imaging device within the self-checking system 1 for the inspection device according to an embodiment of the present disclosure.

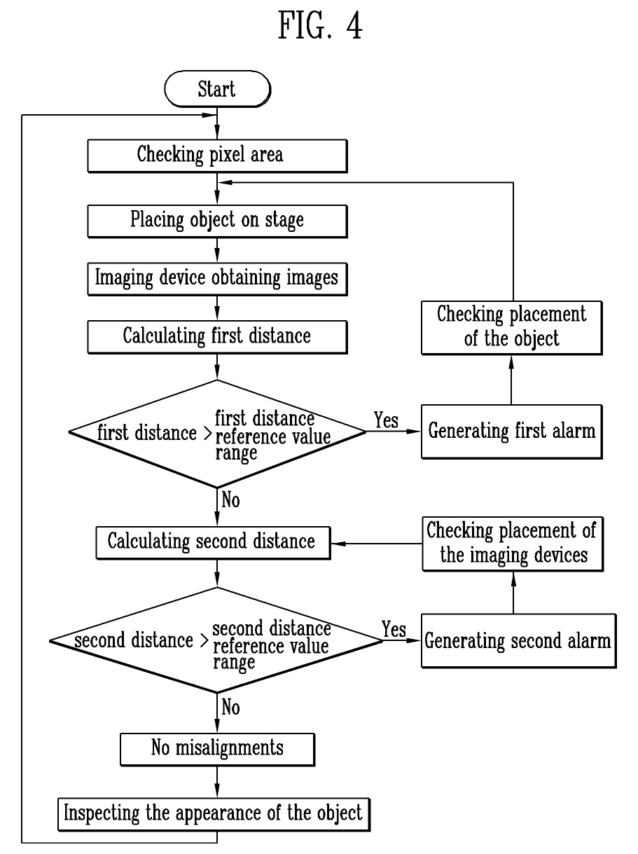

Furthermore, FIG. 4 is a flowchart schematically illustrating a step of determining whether the placement of the object 200 and the placement of the top imaging device 301 are misaligned through a self-checking system 1 for the inspection device according to an embodiment of the present disclosure.

As shown in FIGS. 2 to 4, the self-checking system 1 for the inspection device according to an embodiment of the present disclosure may determine whether there is an offset in the placement of the object 200 or an offset in the placement of the top imaging device 301 based on the top-surface image obtained from the top imaging device 301.

In an embodiment, the determination unit may calculate a first distance ℓ1 from a reference point 211 of the object 200 within the top-surface image to the top pixel area 113, and determines that the placement position of the object 200 is misaligned when the first distance ℓ1 exceeds a first distance reference value range. Further, the alarm unit 500 may generate a first alarm sound when the determination unit determines that the placement position of the object 200 is misaligned.

For example, in an embodiment of the present disclosure, the determination unit 400 calculates a first distance ℓ1 from the surface reference point 211 of the object 200 within the surface image to the top pixel area 113, and if the first distance ℓ1 exceeds a predetermined range, the placement position of the object 200 can be determined to be misaligned, and the alarm unit 500 can generate a first alarm sound.

For example, as shown in FIGS. 2 and 4, the determination unit 400 can calculate the first distance ℓ1 from the reference point 211 of the object 200 in the top-surface image obtained from the top imaging device 301 to the top pixel area 113. Next, if the calculated first distance ℓ1 exceeds the reference value range for the first distance ℓ1 stored in the determination unit 400, the placement position of the object 200 relative to the stage 100 is determined to be misaligned. The alarm unit 500, receiving a signal from the determination unit 400, generates a first alarm sound to alert the operator that the placement position of the object 200 relative to the stage 100 is misaligned. For example, an operator hearing the first alarm sound can check and adjust the placement position of the object 200 relative to the stage 100.

In an embodiment, the determination unit 400 may calculate a second distance ℓ2 from a reference point 111 of the stage 100 within the top-surface image to the top pixel area 113, and determine that the placement of the top imaging device 301 is misaligned when the second distance ℓ2 exceeds a second distance reference value range. Further, the alarm unit 500 may generate a second alarm sound when the determination unit 200 determines that the placement of the top imaging device 301 is misaligned.

For example, the determination unit 400 calculates a second distance ℓ2 from the reference point 111 of the stage 100 in the top-surface image to the top pixel area 113. If the calculated second distance ℓ2 exceeds a predetermined range for the second distance ℓ2, the alarm unit 500 can generate a second alarm sound.

For example, after determining whether the placement of the object 200 on the stage 100 is misaligned, if the alarm unit 500 does not sound an alarm, i.e., if the object 200 is determined to be correctly positioned on the stage 100, the determination unit 400 can calculate a second distance ℓ2 from the stage 100 reference point 111 in the top-surface image to the top pixel area 113 of the object 200. Next, if the calculated second distance ℓ2 exceeds the reference value range for the second distance stored in the determination unit 400, the placement of the top imaging device 301 is determined to be misaligned, and the alarm unit 500 receives a signal from the determination unit 400 to generate a second alarm sound, alerting the operator that the placement of the top imaging device 301 is misaligned. For example, upon hearing the second alarm sound, the operator can inspect and adjust the placement of the top imaging device 301.

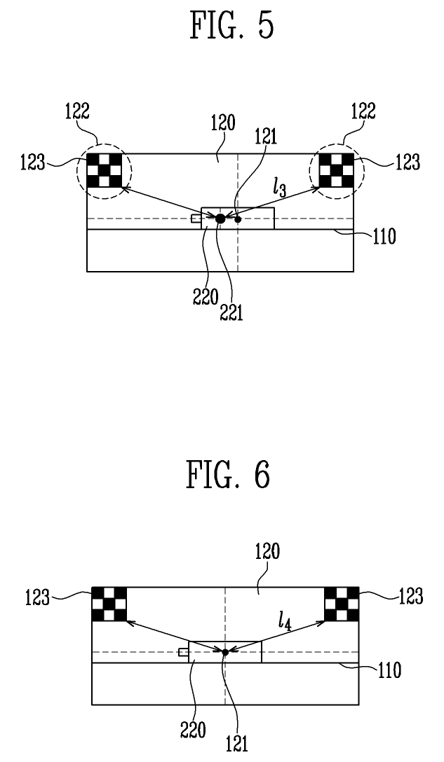

FIG. 5 schematically shows a misalignment of the placement of the object 200 in the self-checking system 1 for the inspection device according to another embodiment of the present disclosure. FIG. 6 schematically shows a misalignment of the side imaging device 302 in the self-checking system 1 for the inspection device according to another embodiment of the present disclosure.

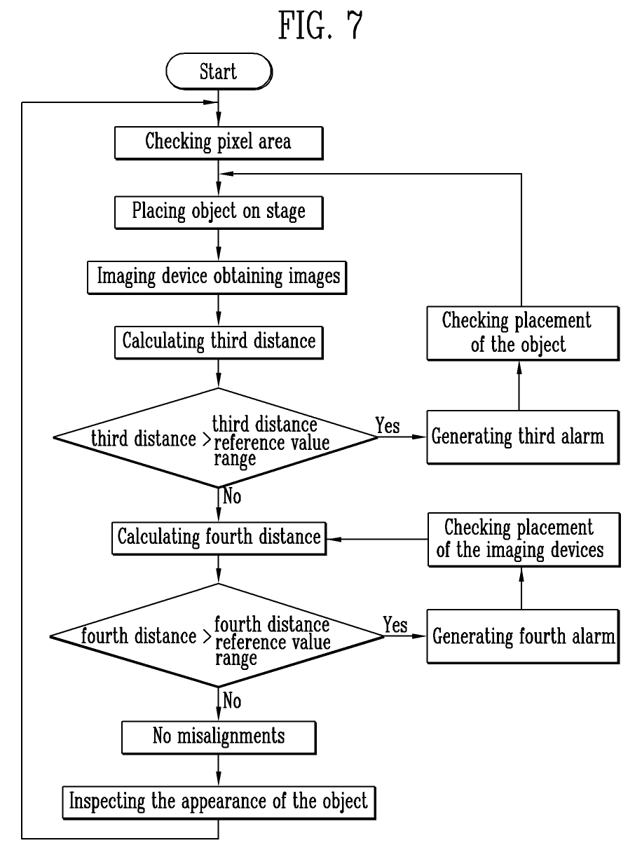

Furthermore, FIG. 7 is a flowchart schematically illustrating a step of determining whether the placement of the object 200 and the placement of the side imaging device 302 are misaligned through a self-checking system 1 for the inspection device according to another embodiment of the present disclosure.

As shown in FIGS. 5 to 7, the self-checking system 1 for the inspection device according to another embodiment of the present disclosure can determine whether there is an offset in the placement of the object 200 or an offset in the placement of the side imaging device 302 based on the side image obtained from the side imaging device 302.

In an embodiment, the determination unit 400 may calculate a third distance ℓ3 from a reference point 221 of the object 200 within the side image to the side pixel area 123, and determine that the placement of the object 200 is misaligned when the third distance ℓ3 exceeds a third distance reference value range. Further, the alarm unit 500 may generate a third alarm sound when the determination unit determines that the placement position of the object 200 is misaligned.

For example, the determination unit 400 calculates a third distance ℓ3 from the side reference point 221 of the object 200 in the side image to the side pixel area 123. If the calculated third distance ℓ3 exceeds a predetermined range for the third distance, the alarm unit 500 can generate a third alarm sound.

For example, as shown in FIGS. 5 and 7, the determination unit 400 can calculate the third distance ℓ3 from the side reference point 221 of the object 200 in the side image obtained from the side imaging device 302 to the side pixel area 123. Next, if the calculated third distance ℓ3 exceeds the reference value range for the third distance ℓ3 stored in the determination unit 400, the placement position of the object 200 relative to the stage 100 is determined to be misaligned. The alarm unit 500, receiving a signal from the determination unit 400, generates a third alarm sound to alert the operator that the placement position of the object 200 relative to the stage 100 is misaligned. For example, an operator hearing the third alarm sound can check and adjust the placement position of the object 200 relative to the stage 100.

In an embodiment, the determination unit 400 may calculate a fourth distance ℓ4 from a reference point 121 on the stage within the side image to the top pixel area 123, and determine that the placement of the side imaging device 302 is misaligned when the fourth distance ℓ4 exceeds a fourth distance reference value range. Further, the alarm unit 500 may generate a fourth alarm sound when the determination unit determines that the placement of the side imaging device 302 is misaligned.

For example, the determination unit 400 calculates a fourth distance ℓ4 from a side reference point 121 of the stage 100 in the side image to a side pixel area 123, and if the calculated fourth distance ℓ4 exceeds the reference value range for the fourth distance ℓ4, it determines that the placement of the side imaging device 302 is misaligned, and the alarm unit 500 can generate a fourth alarm sound.

For example, after determining whether the placement of the object 200 relative to the stage 100 is misaligned, if there is no alarm from the alarm unit 500, i.e., if the object 200 is determined to be correctly positioned relative to the stage 100, the determination unit 400 can calculate the fourth distance ℓ4 from the side reference point 121 of the stage 100 in the side image to the side pixel area 123. Next, if the calculated fourth distance ℓ4 exceeds the fourth distance ℓ4 reference value range stored in the determination unit 400, it determines that the placement of the side imaging device 302 is misaligned, and the alarm unit 500 receives a signal from the determination unit 400 to generate a fourth alarm sound, alerting the operator that the side imaging device 302 is misaligned. For example, upon hearing the fourth alarm sound, the operator can inspect and adjust the placement of the side imaging device 302.

Therefore, by operating the self-checking system 1 for the inspection device according to an embodiment or another embodiment of the present disclosure, the effects caused by the placement offset of the object 200 or the misaligning of the imaging devices can be preemptively eliminated. This enables accurate inspection of the actual appearance of the object 200 and allows for a more precise determination of whether defects have occurred in the appearance of the object 200.

With reference to the foregoing descriptions, those skilled in the art to which the present invention pertains will understand that the present disclosure may be implemented in other specific forms without changing its technical concept or essential features.

The scope of the present disclosure is defined by the appended claims rather than the foregoing detailed description, and all modifications or variations derived from the meaning and scope of the claims and the concept of equivalents should be interpreted as falling within the scope of the invention.

What is claimed is:

1. A self-checking system for an inspection device, comprising:
a stage;
an object to be inspected placed on the stage;
a plurality of imaging devices arranged around the object;
a determination unit determining whether there is an offset between the object and placements of the plurality of imaging devices based on a plurality of images obtained from the plurality of imaging devices; and
an alarm unit alerting the presence or absence of the offset determined by the determination unit.

2. The self-checking system according to claim 1, wherein the plurality of imaging devices include:
a top imaging device positioned on a top-surface of the object to obtain a top-surface image; and
a side imaging device positioned on a side of surface of the object to obtain a side-surface image.

3. The self-checking system according to claim 2, wherein the stage includes a plurality of side walls standing upright from a bottom surface of the stage.

4. The self-checking system according to claim 2, wherein the stage includes a top pixel area formed in a corner region of the bottom surface of the stage.

5. The self-checking system according to claim 3, wherein the stage includes a side pixel area formed in a corner region of the side wall.

6. The self-checking system according to claim 5, wherein the determination unit determines that the placement of the top imaging device or the side imaging device is misaligned when the mapping value of the top pixel area or the side pixel area exceeds a reference mapping value.

7. The self-checking system according to claim 6, wherein the determination unit calculates a first distance from a reference point of the object within the top-surface image to the top pixel area, and determines that the placement position of the object is misaligned when the first distance exceeds a first distance reference value range.

8. The self-checking system according to claim 7, wherein the alarm unit generates a first alarm sound when the determination unit determines that the placement position of the object is misaligned.

9. The self-checking system according to claim 6, wherein the determination unit calculates a second distance from a reference point of the stage within the top-surface image to the top pixel area, and determines that the placement of the top imaging device is misaligned when the second distance exceeds a second distance reference value range.

10. The self-checking system according to claim 9, wherein the alarm unit generates a second alarm sound when the determination unit determines that the placement of the top imaging device is misaligned.

11. The self-checking system according to claim 6, wherein the determination unit calculates a third distance from a reference point of the object within the side image to the side pixel area, and determines that the placement of the object is misaligned when the third distance exceeds a third distance reference value range.

12. The self-checking system according to claim 11, wherein the alarm unit generates a third alarm sound when the determination unit determines that the placement position of the object is misaligned.

13. The self-checking system according to claim 6, wherein the determination unit calculates a fourth distance from a reference point on the stage within the side image to the top pixel area, and determines that the placement of the side imaging device is misaligned when the fourth distance exceeds a fourth distance reference value range.

14. The self-checking system according to claim 13, wherein the alarm unit generates a fourth alarm sound when the determination unit determines that the placement of the side imaging device is misaligned.
